(19) United States
(12) Patent Application Publication
(10) Pub. No.: US 2007/0192704 A1
(43) Pub. Date: Aug. 16, 2007

(54) Method, apparatus and computer program product for port configuration of resources in a virtual topology

(75) Inventors: Mark L. Bauman, Rochester, MN (US); Joseph B. Brinkmeier, Beavercreek, OH (US); Stephen T. Eagen, Rochester, MN (US); Anthony W. Erwin, Rochester, MN (US); Sepideh Gazeri, Irvine, CA (US); Jonathan Lee, Round Rock, TX (US); Timothy C. Mossing, Rochester, MN (US); Michael Vance, Houghton, MI (US)

Correspondence Address: CANTOR COLBURN LLP - IBM ROCHESTER DIVISION, 55 GRIFFIN ROAD SOUTH, BLOOMFIELD, CT, 06002, US

(73) Assignee: INTERNATIONAL BUSINESS MACHINES CORPORATION, ARMONK, NY (US)

(21) Appl. No.: 11/351,957

(22) Filed: Feb. 10, 2006

(51) Int. Cl. G06F 15/177

(52) U.S. Cl. 715/735; 709/220

(57) ABSTRACT

A port configuration utility includes a graphic depiction of resources within a topology, and provides a user with at least a control panel for selecting ports of resources within the topology, configuring the ports and monitoring the status of the ports. The port configuration utility may include additional features for scheduling operations as well as accessing and managing port related information.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

The present disclosure relates generally to implementation of computer network resources and, in particular, to implementation of firewall solutions.

As the number of managed resources in a company increases, it becomes more difficult for a system administrator to configure firewalls. Some of the challenging aspects of the configuration process include the heterogeneous nature of resources and the visualization of the relationships between resources in a network. Managing firewalls becomes confusing, tedious and requires expert oversight.

Many firewall configuration tools are available today. Examples range from software included on routers, to enterprise network management software, one example of the former being the D-Link DI-604 router, which contains basic firewall capabilities, one example of the latter being the Cisco Secure Policy Manager, which provides topology-aware firewall management. However, these existing products only provide the ability to configure firewalls on specific routers. They do not provide for detection of relationships with other resources within the network, and therefore do not provide a desired level of protection.

What network administrators need is a tool that enables them to implement complex firewall solutions by choosing virtual resources, regardless of platform for protection.

### BRIEF SUMMARY OF THE INVENTION

Disclosed herein is an apparatus for configuring at least one port in a topology, the apparatus including means for selecting from within a graphic depiction of the topology at least one resource comprising at least one port; means for selecting the at least one port; means for selecting a configuration for the at least one port; and means for applying the at least one configuration to the at least one port.

Also disclosed is a computer program product stored on machine readable media and for configuring at least one port in a topology, the computer program product including instructions for selecting from within a graphic depiction of the topology, at least one resource having at least one port; selecting at least one port of the at least one resource; configuring at least one port setting for the at least one port; and, applying the at least one port setting to the at least one port.

Further disclosed is a port configuration utility for configuring at least one port in a network of resources, the port configuration utility that includes a graphic depiction of the network, the utility having tools for selecting from the depiction at least one resource having at least one port; the utility further including a control panel for at least one of configuring the at least one port and obtaining a status of the at least one port. Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution that includes a port configuration utility having a graphic depiction of resources within a topology, and provides a user with at least a control panel for selecting ports of resources within the topology, configuring the ports and monitoring the status of the ports. The port configuration utility may include additional features for scheduling operations as well as accessing and managing port related information. The port configuration utility provides for higher speed of completion for some administrative tasks, as well as increased security of resources, through a simple user interface that provides direct control over port settings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts an embodiment of a user-interface showing aspects of a network topology;

FIG. 2 depicts the user-interface where ports have been applied to selected resources;

FIG. 3 depicts a result for the grouping depicted in FIG. 2;

FIG. 4 depicts a port configuration for a selected port;

FIG. 5 depicts exemplary graphical annotations;

FIG. 6 depicts aspects of one method for use of a port configuration utility; and,

FIG. 7 depicts aspects of a second method for use of the port configuration utility.

The detailed description explains the preferred embodiments of the invention, together with advantages and features, by way of example with reference to the drawings.

### DETAILED DESCRIPTION OF THE INVENTION

The capabilities of the present invention can be implemented in software, firmware, hardware or some combination thereof. As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately. Additionally, at least one program storage device readable by a machine, tangibly embodying at least one program of instructions executable by the machine to perform the capabilities of the present invention can be provided.

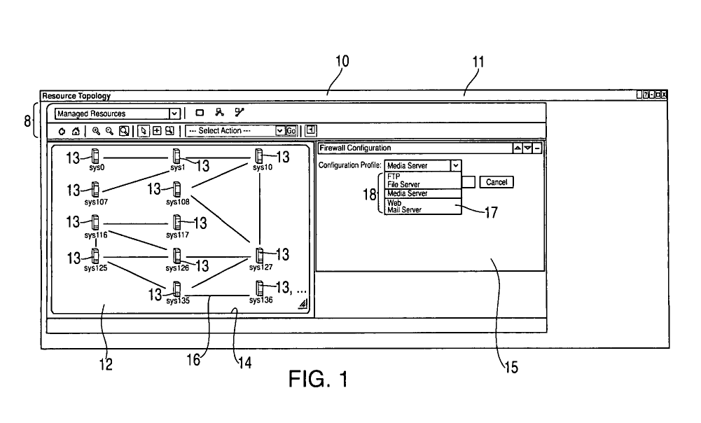

FIG. 1 depicts an exemplary user-interface 11 for a port configuration utility 10. In the exemplary embodiment depicted by FIG. 1, a user makes use of the port configuration utility 10 to configure firewall settings for certain resources 13 (that have been configured as media servers). In this embodiment, the port configuration utility 10 provides a graphic depiction 14 of a topology 12 for resources 13 available to the user. Each of the resources 13 includes various components (not shown) known to those skilled in the art. For example, any one or more of the resources 13 may include, without limitation, at least one processor, a user interface (including, in non-limiting examples, a mouse, a keyboard, a monitor, a printer, a pointing device, a writing tablet, a camera, a microphone and an audio output), a storage (including, in non-limiting examples, a hard drive, a floppy drive, a tape drive, an optical drive, a magneto-optical drive, static memory and dynamic memory) and other devices. Non-limiting examples of resources 13 include a router, a bridge, an FTP server, a file server, a media server, a web server, and a mail server.

The user-interface 11 typically includes other facilities, such as at least one dynamic tool bar 8. The tool bar 8 typically provides users with quick access to tools such as context sensitive or frequently used commands or information. As such toolbars are generally known in the art, these are not discussed further herein.

In the typical embodiment, the user makes use of the graphic depiction 14 to select resources 13 within the topology 12. Once the selected resource 13 has been recognized by the port configuration utility 10, a control panel 15 may be used to configure aspects of the resource 13. As depicted in FIG. 1, the control panel 15 may be used to configure firewall settings for various groups of resources 13, in this case Media Servers. Note that in FIG. 1, resources “Sys 116,” “Sys 108,” “Sys 117,” “Sys 135,” and Sys 136″ are highlighted in the graphic depiction 14, or more to the point, selected within the topology 12. Although the graphic depiction 14 only shows host systems or nodes of a selected network 16, it should be understood that the port configuration utility 10 may be applied at various levels within the network 16 (that is, other than just to selected node level resources 13).

Note that as used herein, the term “topology” makes reference to aspects of the design and virtual depiction of the actual network 16. Accordingly, the topology 12 and the network 16 are closely related, and in some instances, the terms are synonymous.

In the typical embodiment, and as disclosed herein, the port configuration utility 10 is native to one environment, such as for personal computers (one example being WINDOWS by MICROSOFT Corporation). However, the port configuration utility 10 is typically operable across a variety of platforms and operating systems. Typically, the port configuration utility 10 is implemented as a computer code which uses one of the resources 13 in the network 16, such as a terminal dedicated for use by a network administrator. Preferably, the port configuration utility 10 is programmed using known software development tools. In some embodiments, the port configuration utility 10 is implemented through a browser interface.

The port configuration utility 10 makes use of known techniques and environment features for to ascertain required information. For example, in one embodiment, the port configuration utility 10 interrogates resources 13 to obtain status of selected ports. In other embodiments, the port configuration utility 10 includes various components resident in each of the resources 13, wherein the components communicate with the port configuration utility 10 to provide information and control over aspects of the respective resource 13.

Accordingly, it should be understood that the resources 13 depicted may be unique to each other in a variety of ways. Accordingly, it should be understood that the port configuration utility 10 is disclosed herein in terms of the WINDOWS environment. For example, the terms “port” and “ports” are generally defined by aspects thereof known to those skilled in the art. However, it must be recognized that aspects of these teachings are applicable to other platforms and environments. Therefore, the teachings herein are merely illustrative and not limiting of the invention.

In typical embodiments, the user can check for a status of any one up to all of the ports on any one up to all of the selected resources 13. In doing so, the port configuration utility 10 queries the selected resources 13 for the status of each of the selected ports and displays the result.

An exemplary use of the port configuration utility 10 involves managing aspects of firewalls within the topology 12. Although discussed herein as a technique for configuring firewall settings, it is recognized that the port configuration utility 10 may be used to govern many other aspects of ports and uses thereof.

When managing firewall configurations, typically, the user (i.e., the network administrator) will use the port configuration utility 10 to block or unblock any number of ports across the selected resources 13. The user is able to specify an identity (such as a URL) of a firewall to be configured. Following identification, the port configuration utility 10 is used to create or modify at least one filter, such as an IP filter, for the firewall. Typically, the firewall resides on a gateway to the resources 13 in order to provide for maximum security. In order to create or modify filters, a common framework for router configuration is typically implemented. The common framework is preferably a part of the management software and effectively virtualizes all routers on the network 16. Since most routers include a web interface, implementing the common framework for managing configurations of resources 13 is straightforward. In some embodiments, the common framework takes advantage of the web interface, and other aspects of the resources 13. For example, the common framework in some embodiments is designed to prompt the user for credentials in order to authenticate proper authority to manage configurations within the network 16.

In some embodiments, additional features such as monitoring and scheduling of configurations are included. Non-limiting and additional examples of features of the port configuration utility 10 include: a capability to create and apply port configuration profiles; a capability to filter graphical display of resources based on port status; a capability to view the status of the selected port by specifying a port number or an application associated with the port; and a capability to provide a graphical annotation of port status. Each of these exemplary and non-limiting capabilities is now discussed in more detail.

With regard to creating and applying port configuration profiles, it is recognized that some resources 13 in the typical network 16 perform unique functions. For example, a mail server handles all the incoming and outgoing mail. For this type of resource 13, a network administrator can use the port configuration utility 10 to create a port configuration profile that specifies which ports should be blocked and which ports should not be blocked. The port configuration profile can be saved and applied to other resources 13 in the network 16 as deemed appropriate. For example, the port configuration profile may be applied to a secondary mail server. In other words, port configuration profiles can be applied by the user to set configurations quickly and easily. Reference may be had to FIG. 1, wherein a selection menu 17 (in this case, a pull-down style menu) in the control panel 15 is used to select the desired port configuration profile 18 to apply to the resources 13.

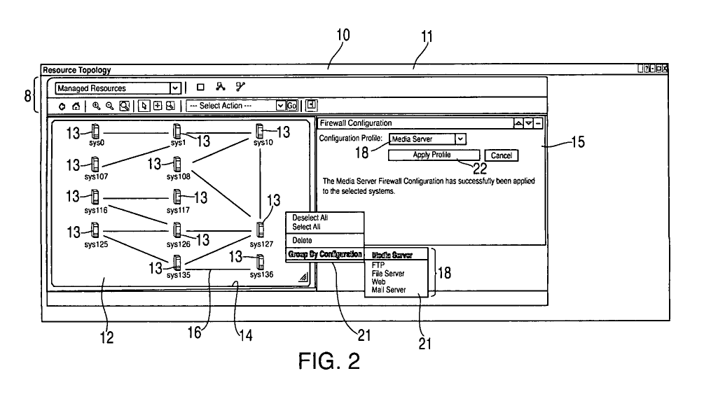

Referring also to FIG. 2, the port configuration utility 10 may make use of various techniques known in the art for selecting and applying settings. For example, the port configuration utility 10 may use at least one secondary menu 21. In the embodiment depicted in FIG. 2, the at least one secondary menu 21 materializes as a pop-up menu when appropriate, and provides for refinement to selecting of the configuration settings. Also depicted in FIG. 2, is an applying facility 22. In this case, the applying facility 22 is a push-button tool for accepting selected configuration settings.

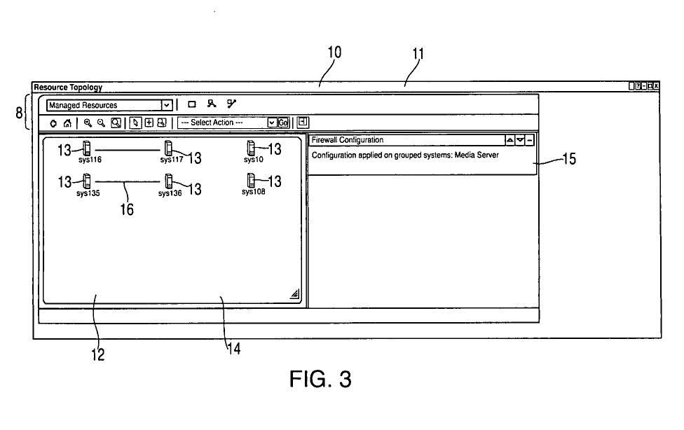

Further, as depicted in FIG. 3, the graphic depiction 14 and the control panel 15 may provide dynamic displays of salient information. That is, in this embodiment, the resources 13 that have been configured according to the techniques discussed above in reference to FIG. 1 and FIG. 2 are displayed according to the newly defined configuration. This revised configuration may be confirmed (as is depicted) by a suitable statement in the control panel 15.

Accordingly, and as depicted in FIG. 3, the port configuration utility 10 provides the user with graphical display of aspects of interest for selected resources 13. That is, the port configuration utility 10 provides users with capabilities to group resources 13 according to port status in a graphical manner. This provides a convenient and quick technique for an administrator to filter resources 13 based on their port status. As an example, the administrator may select and display all systems that have blocked port 1214, used for peer-to-peer file sharing. An administrator could also apply a separate filter, such as one that identifies and displays all systems that have not blocked port 1214.

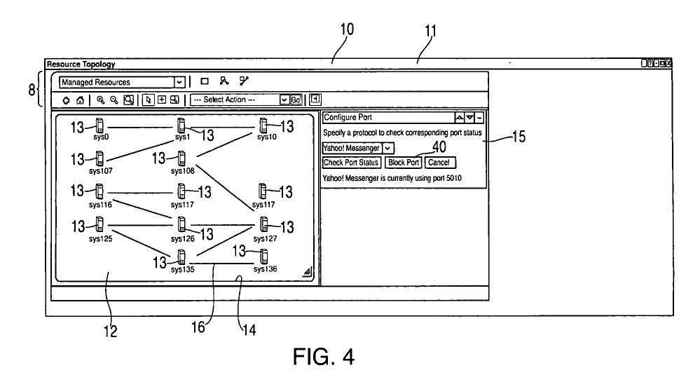

After performing this latter filter, the administrator could proceed to block the peer-to-peer file sharing application on the remaining systems. These techniques are more apparent with reference to FIG. 4.

Referring now to FIG. 4, in the appropriate context, the control panel 15 provides facilities for checking port status according to a protocol. In this case, the protocol is for “Yahoo! Messenger.” A statement or other indication (such as a legend) may be returned from a query operation. In this case, the statement indicates the protocol is using port 5010. Typically, the control panel 15 provides users with control features, such as a toggle 40 to block the selected port, or to remove a block from the selected port.

A further and exemplary feature of the port configuration utility 10 includes the capability to view (i.e., return) the status of a port by specifying a port number or an application associated with the use of the port. For example, an application as defined by the Internet Assigned Numbers Authority. More specifically, many of the resources 13 may include a large number (e.g., thousands) of ports. A user can not practically memorize the port number that a specific application uses. Accordingly, this feature enables the user to specify an application name and search for the associated port to view the status of the port. Advanced users can specify a port number rather than search by application.

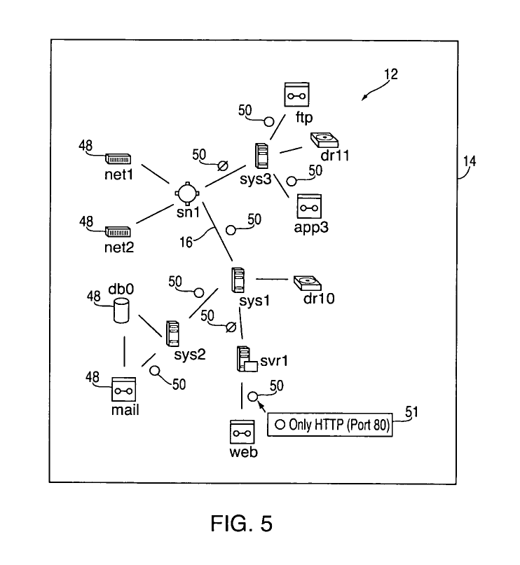

As a further exemplary feature of the port configuration utility 10, a user can drill down into a resource and view a graphical annotation of the port statuses to help identify which ports have been configured. Reference may be had to FIG. 5, which helps describe this feature.

In FIG. 5, various resource identifiers 48 are provided within the graphic depiction 14 of the topology 12 discussed above with reference to FIG. 1 though FIG. 4. In this embodiment, the resource identifiers 48 include descriptive icons and text. That is, the descriptive icons provide meaningful pictures of the type of resource 13 (the resources 13 referenced in the graphic depiction 14 being one of a mail server (mail), a storage system (db0), and a network server (net1 and net2)). Also included in the graphic depiction 14 are a series of indicators 50. In this embodiment, the indicators 50 provide a graphic presentation regarding the status of ports related to the operation of the network 16. For example, the indicators 50 may signify that all the ports associated with a resource 13 are blocked or available, or that some fraction of the associated ports are blocked or available. Other facilities may be included, such as pop-up information 51 that appears when a pointer hovers over a specific resource 13 within the network 16. In this instance, the pop-up information 51 indicates “Only HTTP (Port 80)” is blocked for a resource 13. In some embodiments, the user is provided with resources, such as a pop-up control panel 15 to manage the associated ports, such as described above. The pop-up version of the control panel 15 may be invoked by techniques, such as right clicking over the resource 13.

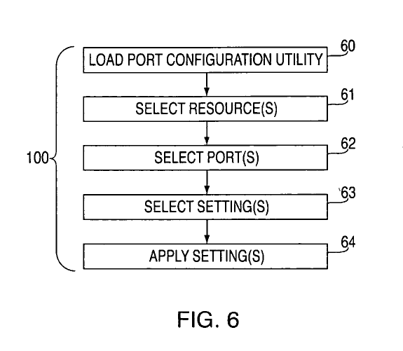

An exemplary method for using the port configuration utility 10 is depicted in FIG. 6. In FIG. 6, operating the port configuration utility 100 includes loading the port configuration utility 60, selecting at least one resource 61, selecting at least one port 62, selecting at least one port setting for the at least one resource 63, and applying the at least one port setting 63.

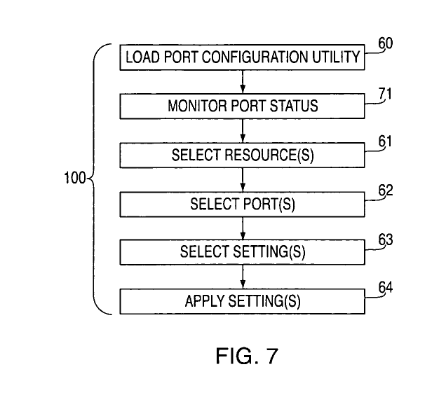

Another exemplary technique for using the port configuration utility 10 is depicted in FIG. 7. In FIG. 7, operating the port configuration utility 100 includes loading the port configuration utility 60, then, by using the graphic depiction, monitoring port status 71, selecting at least one resource 61, selecting at least one port 62, configuring at least one port setting for the at least one resource 63, and applying the at least one port setting 63 to the at least one port.

The flow (and other) diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A port configuration utility for configuring at least one port in a computer network comprising a plurality of resources, the port configuration utility comprising:
a graphic depiction of the network, the utility comprising tools for selecting from the depiction at least one resource comprising at least one port; the utility further comprising a control panel for at least one of configuring a setting of the at least one port and obtaining a status of the at least one port.

2. The port configuration utility as in claim 1, comprising at least one of a router, a bridge, an FTP server, a file server, a media server, a web server, and a mail server.

3. The port configuration utility as in claim 1, wherein the setting comprises a firewall setting.

4. The port configuration utility as in claim 1, wherein at least one of the tools and the control panel comprises a toolbar.

5. The port configuration utility as in claim 1, further comprising a facility for at least one of saving a configuration for the at least one port and retrieving a saved configuration for the at least one port.

6. The port configuration utility as in claim 1, wherein the graphic depiction comprises tools for grouping a plurality of ports.

7. The port configuration utility as in claim 1, wherein the graphic depiction comprises at least one of an icon, a text label and a diagram of the topology.

8. The port configuration utility as in claim 1, wherein the control panel comprises at least one of a pop-up window, a pull-down menu and a push button.

9. The port configuration utility as in claim 1, wherein an operating environment for the utility comprises an environment for personal computers.

10. A computer program product stored on machine readable media and for configuring at least one port in a topology, the computer program product comprising instructions for:
selecting from within a graphic depiction of the topology, at least one resource comprising at least one port;
selecting at least one port of the at least one resource;
configuring at least one port setting for the at least one port; and,
applying the at least one port setting to the at least one port.

11. The computer program product as in claim 10, further comprising instructions for at least one of monitoring a status of the at least one port and scheduling the applying of the setting to the at least one port.

12. The computer program product as in claim 10, further comprising instructions for returning a status of the at least one port by at least one of specifying a port number and an application number.

13. The computer program product as in claim 10, further comprising instructions for grouping a plurality of ports for at least one of the configuring and the applying.

14. The computer program product as in claim 10, wherein the graphic depiction of the topology comprises a graphical annotation of a status for the at least one port.

15. The computer program product as in claim 14, further comprising selecting at least one resource for annotating with the graphical annotation.

16. The computer program product as in claim 10, wherein the applying comprises one of blocking and unblocking the at least one port.

17. The computer program product as in claim 10, further comprising instructions for authenticating a privilege of a user.

18. The computer program product as in claim 10, further comprising instructions for at least one of saving a configuration and retrieving a saved configuration.

19. An apparatus for configuring at least one port in a topology, the apparatus comprising:
means for selecting from within a graphic depiction of the topology at least one resource comprising at least one port;
means for selecting the at least one port;
means for selecting a configuration for the at least one port; and
means for applying the at least one configuration to the at least one port.

20. The apparatus of claim 19, wherein the at least one resources comprises at least one of a router, a bridge, an FTP server, a file server, a media server, a web server, and a mail server.
